(19) United States
(12) Patent Application Publication
(10) Pub. No.: US 2006/0012195 A1
(43) Pub. Date: Jan. 19, 2006

(54) All-in-one pooper scooper

(76) Inventor: Stephen Scala, Mission Viejo, CA (US)

Correspondence Address: STEPHEN SCALA, 28462 BORGONA, MISSION VIEJO, CA, 92692, US

(21) Appl. No.: 10/889,929

(22) Filed: Jul. 14, 2004

(51) Int. Cl. A01K 29/00

(52) U.S. Cl. 294/1.4

(57) ABSTRACT

This invention eliminates the need to bend down with one hand placed in a bag ready to Pick up dog excrement. Most devices can pick up but remain soiled. The “All in one Scooper” remains clean and is designed to carry needed supplies aboard. Other supplies such as, water container, a small amount of sand, a few first aid articles, paper towels, liquid bacterial soap, and insect repellent. These are carried in the type of bag used for the Scooper part C. Once Scooper is placed over the feces, a pull (100 lb. line strength) on the ring 6 “fingers” load the bag and holds it tightly. Turning the Scooper over permits the bag to be twisted-closed and disposed of. A twist tie may be applied A dowel stick fitted end (tissue covered when in use) is used to gather pieces of feces left scattered beyond the range of the Scooper, The Scooper itself can perform this function; Therefore, the stick is of a convenience item.

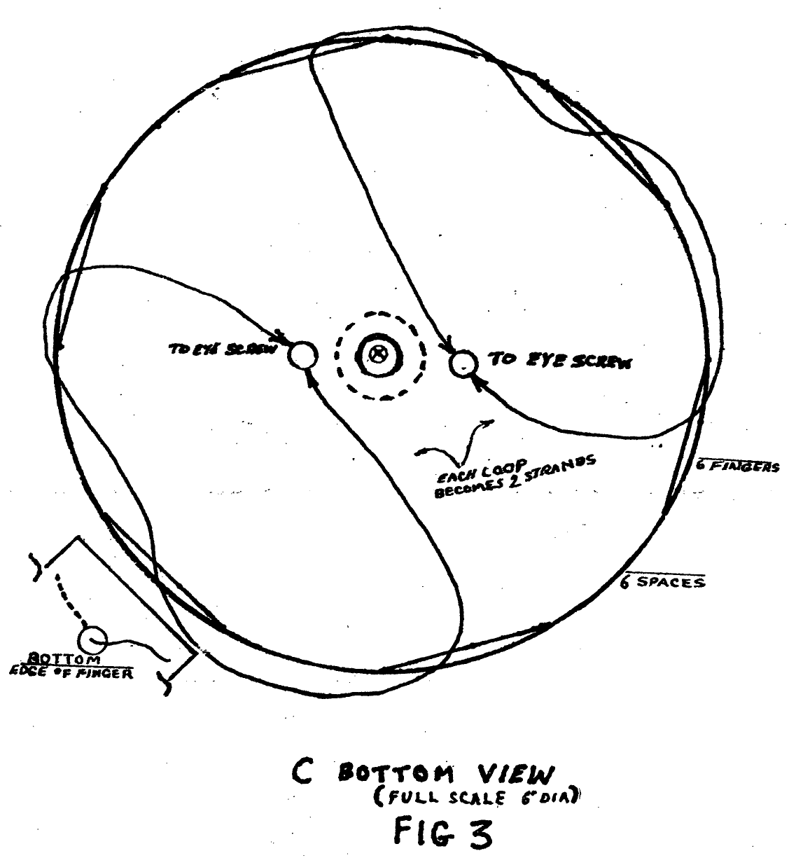

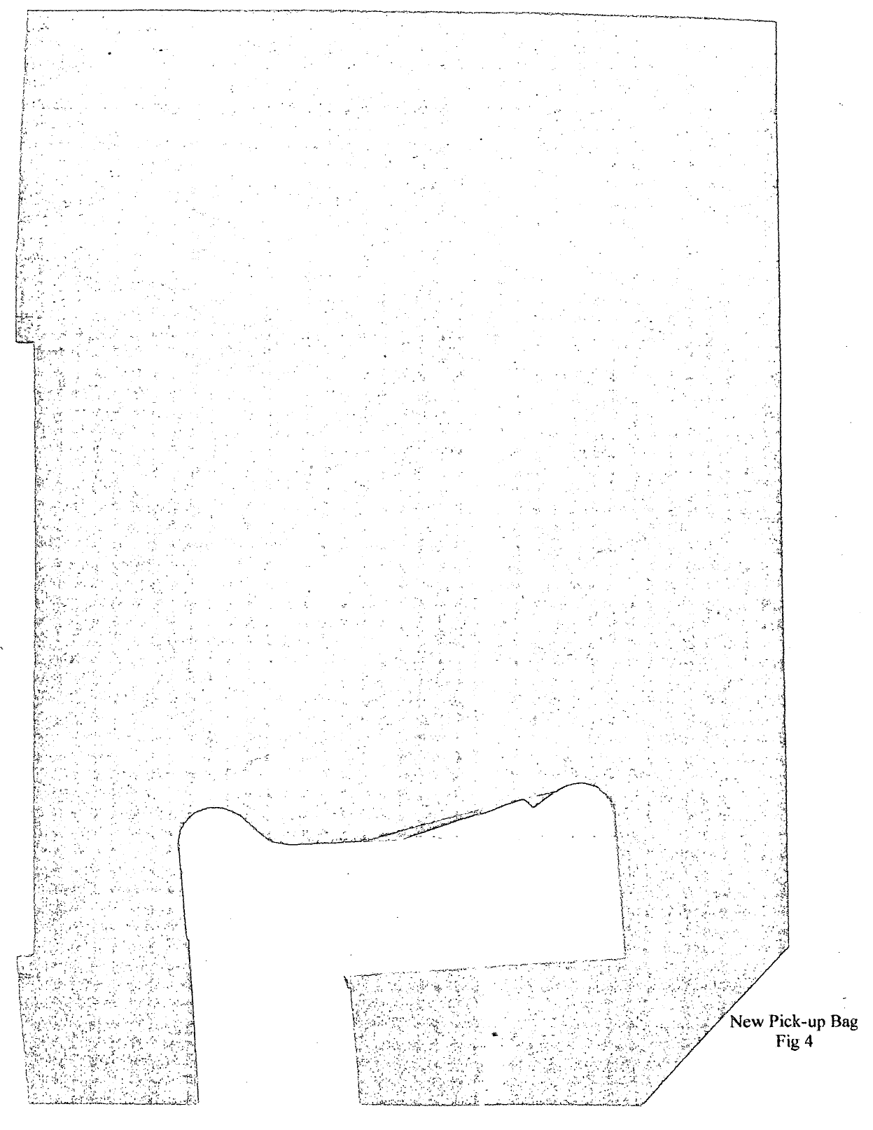

FIG. 4 shows the bag that is commonly used and readily available.

Part A is a ¾ in×30 in dowel stick handle to which the Spectra line B is attached. The Line passes through two eye screws and is connected to an O-ring at the end. Part A also has two supply caddies attached. The Spectra line attaches to both parts A and C. The line has a breaking strength of approximately 100 lb.

Part B is the actuator for Part C The line passes through C at the top and is connected to the 6 “fingers” completing their function.

The length of Spectra line used in the finished product is 6-8 ft.

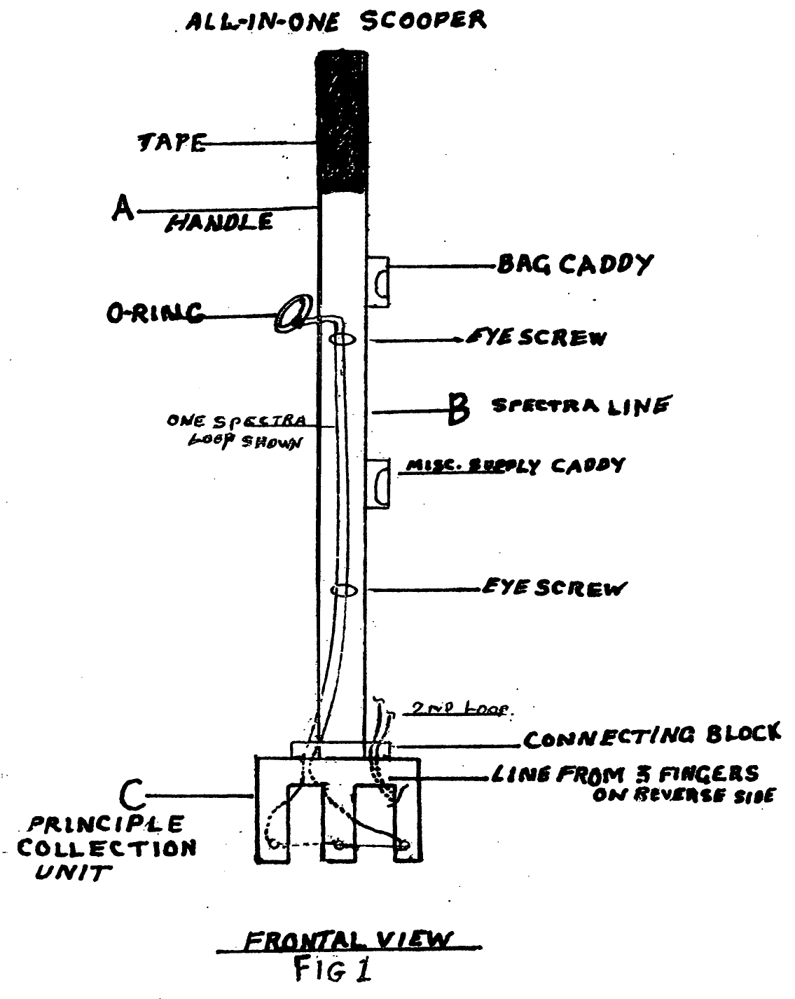

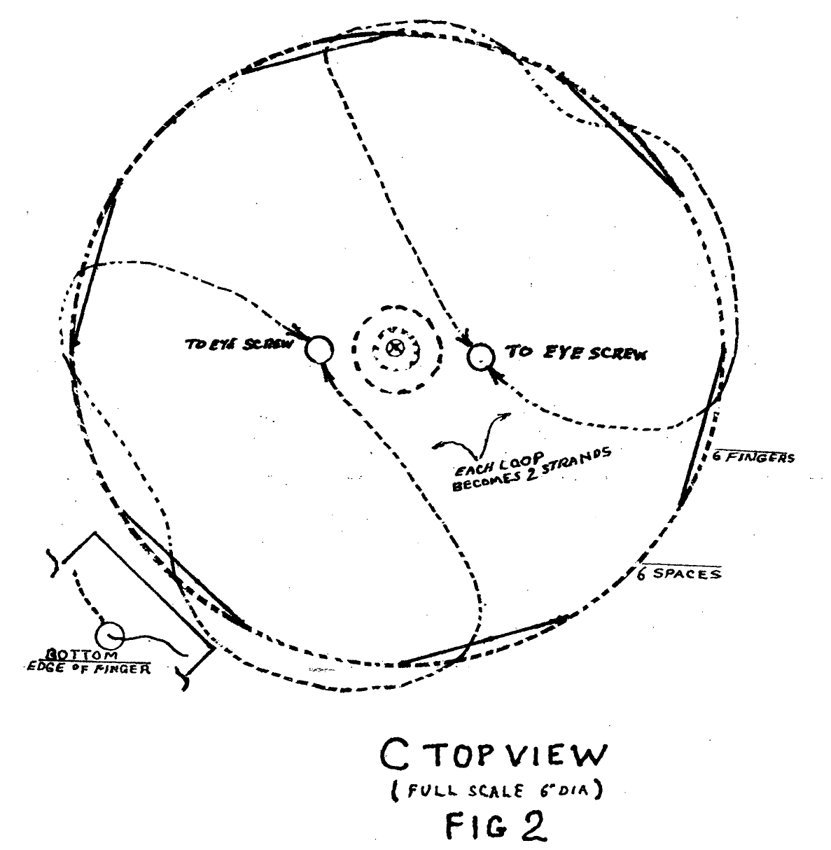

FIG. 1 as sketched represents an approximate 75% reduction overall in size compared to the finished model.

1. The-All-In-One Scooper Remains unsoiled by feces since contact is through plastic and extra bags are aboard.

2. Walking a dog can be a challenge for the elderly and others who often have a problem with balance when bending down. This problem is eliminated which is a safety consideration.

3. The carrying bag used to carry the Scooper will cover mainly Part C and also be able To carry some useful items. In addition the bag can have a fitted shoulder strap.
